(19) United States
(12) Patent Application Publication
(10) Pub. No.: US 2024/0070946 A1
(43) Pub. Date: Feb. 29, 2024

(54) COMPUTER DEVICE AND METHOD FOR DISPLAYING AUGMENTED-REALITY (AR) VIRTUAL KEYBOARD

(71) Applicant: Quanta Computer Inc., Taoyuan City (TW)

(72) Inventor: Yi-Min LIN, Taoyuan City (TW)

(21) Appl. No.: 18/053,020

(22) Filed: Nov. 7, 2022

(30) Foreign Application Priority Data
Aug. 25, 2022 (TW) 111132054

(51) Int. Cl. G06T 11/60; G06F 3/01; G06T 3/40; G06V 20/20; G06V 40/20

(52) U.S. Cl. CPC G06T 11/60; G06F 3/011; G06T 3/40; G06V 20/20; G06V 40/28

(57) ABSTRACT

A computer device is provided, which includes a display device and a host. The host includes a keyboard, a camera, a storage device, and a processor. The storage device is configured to store an augmented-reality keyboard program. The processor is configured to execute the augmented-reality keyboard program to perform the following steps: detecting input method information of an operating system running on the host, and obtaining key arrangement of the keyboard; utilizing the camera to capture an operation image of the keyboard; and when a user's hand is recognized in the operation image, displaying a virtual keyboard on the display device according to the key arrangement and the input method information, and displaying a typing operation of the user's hand by superimposing an augmented-reality hand object on a key position of the virtual keyboard corresponding the typing operation of the user's hand.

### CROSS REFERENCE TO RELATED APPLICATIONS

This application claims priority of Taiwan Patent Application No. 111132054, filed on Aug. 25, 2022, the entirety of which is incorporated by reference herein.

### BACKGROUND OF THE INVENTION

### Field of the Invention

The present invention relates to augmented reality, and, in particular, to a computer device and a method for displaying an augmented-reality (AR) virtual keyboard.

### Description of the Related Art

When typing on a computer device, users often use multilingual input methods, or they may need to input punctuation marks. However, users often make input errors due to switching between input methods for different languages or special symbols, and this can cause an unnecessary waste of time, resulting in poor text input efficiency.

### BRIEF SUMMARY OF THE INVENTION

In an exemplary embodiment, a computer device is provided, which includes a display device and a host. The host includes a keyboard, a camera, a storage device, and a processor. The storage device is configured to store an augmented-reality keyboard program. The processor is configured to execute the augmented-reality keyboard program to perform the following steps: detecting input method information of an operating system running on the host, and obtaining key arrangement of the keyboard; utilizing the camera to capture an operation image of the keyboard; and when a user's hand is recognized in the operation image, displaying a virtual keyboard on the display device according to the key arrangement and the input method information, and displaying a typing operation of the user's hand by superimposing an augmented-reality hand object on a key position of the virtual keyboard corresponding the typing operation of the user's hand.

In some embodiments, the input method information comprises a language and a type of an input method currently used by the operating system, and the processor obtains a product model, size, a number of keys, and the key arrangement corresponding to the keyboard from device information reported by the keyboard. A virtual text on each virtual keyboard key of the virtual keyboard corresponds to the language and the type of the input method.

In some embodiments, the processor adjusts sizes of the virtual keyboard and the augmented-reality hand object according to a resolution and actual size of the display device.

In some embodiments, the augmented-reality keyboard program comprises an image-recognition artificial-intelligence model to recognize the user's hand in the operation image, and to assign a boundary to the recognized user's hand, and to superimpose the augmented-reality hand object on the virtual keyboard according to the boundary.

In some embodiments, the processor further changes the virtual keyboard into a virtual object corresponding to a current usage scenario set by the augmented-reality keyboard program.

In another exemplary embodiment, a method for displaying an augmented-reality keyboard, for use in a computer device is provided. The computer device includes a camera, a keyboard, and a display device. The method includes the following steps: detecting input method information of an operating system running on the host, and obtaining key arrangement of the keyboard; utilizing the camera to capture an operation image of the keyboard; and when a user's hand is recognized in the operation image, displaying a virtual keyboard on the display device according to the key arrangement and the input method information, and displaying a typing operation of the user's hand by superimposing an augmented-reality hand object on a key position of the virtual keyboard corresponding the typing operation of the user's hand.

In some embodiments, the input method information comprises a language and a type of an input method currently used by the operating system, and the method further includes the following step: obtaining a product model, size, a number of keys, and the key arrangement corresponding to the keyboard from device information reported by the keyboard. A virtual text on each virtual keyboard key of the virtual keyboard corresponds to the language and the type of the input method.

In some embodiments, the method further includes the following step: adjusting sizes of the virtual keyboard and the augmented-reality hand object according to a resolution and actual size of the display device.

In some embodiments, the method further includes the following step: utilizing an image-recognition artificial-intelligence model to recognize the user's hand in the operation image, and to assign a boundary to the recognized user's hand, and to superimpose the augmented-reality hand object on the virtual keyboard according to the boundary.

In some embodiments, the method further includes the following step: changing the virtual keyboard to a virtual object corresponding to a current usage scenario set by an augmented-reality keyboard program running on the computer device.

### BRIEF DESCRIPTION OF THE DRAWINGS

The present invention can be more fully understood by reading the subsequent detailed description and examples with references made to the accompanying drawings, wherein:

FIG. 1 is a block diagram of a computer device in accordance with an embodiment of the invention;

FIGS. 2A-2D are diagrams of usage scenarios of the computer device 10 in accordance with different embodiments of the invention; and

FIG. 3 is a flow chart of a method for display an augmented-reality virtual keyboard in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

It should be understood that the words “comprising”, “including” and the like used in this specification are used to indicate the existence of specific technical characteristics, numerical values, method steps, work processes, components and/or components, but not It does not exclude that you can add more technical features, values, method steps, job processing, components, components, or any combination of the above.

The terms such as “first”, “second”, and “third” are used in the claims to modify the elements in the claims, and are not used to indicate that there is a priority order, prior relationship, or is a component before another component, or the time sequence when performing method steps, only used to distinguish components with the same name.

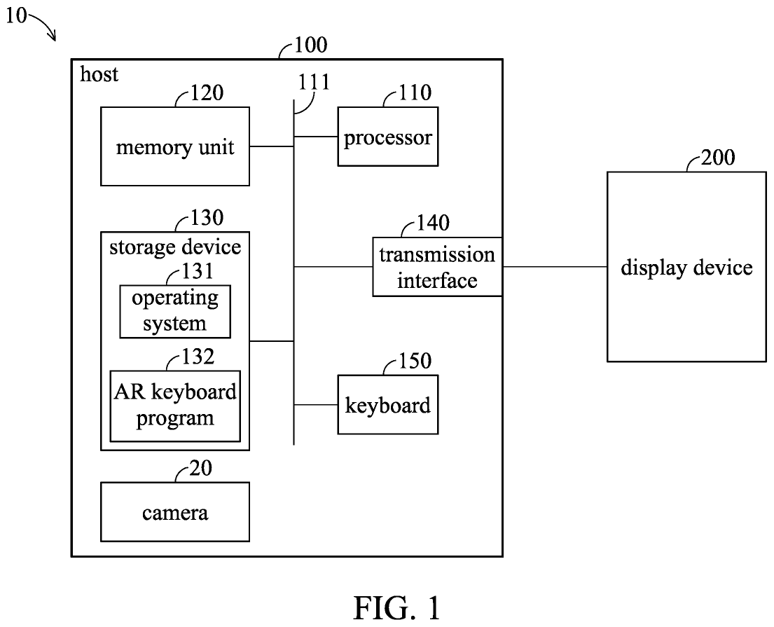

FIG. 1 is a block diagram of a computer device in accordance with an embodiment of the invention.

The computer device 10 may be, for example, a personal computer or a laptop computer. As depicted in FIG. 1, the computer device 10 may include a host 100 and a display device 200. The host 100 is electrically connected to the display device 200. For example, the host 100 may generate an image signal including augmented-reality (AR) virtual object, and transmit the image signal to the display apparatus 200 through a transmission interface 140.

The host 100 may include a processor 110, a memory unit 120, a storage device 130, a transmission interface 140, and a keyboard 150, wherein the aforementioned components in the host 100 are connected to each other through a system bus 111. The processor 110 may be a central processing unit (CPU), a general-purpose processor, etc., but the invention is not limited thereto.

The memory unit 120 may be a random access memory such as a dynamic random access memory (DRAM) or a static random access memory (SRAM), but the invention is not limited thereto. The memory unit 120 may be regarded as a system memory. In addition to temporarily store data by the processor 110, the memory unit 120 may also be used as an image buffer.

The storage device 130 may be a non-volatile memory such as a hard dish drive, a solid-state disk, a flash memory, or a read-only memory (ROM), but the invention is not limited thereto. For example, the storage device 130 may store the operating system 131 (e.g., Windows, Linux, MacOS, etc.) and an augment-reality keyboard program 132. The processor 110 may load the operating system 131 and the AR keyboard program 132 into the memory unit 120 for execution.

The transmission interface is, for example, a wired transmission interface, including High Definition Multimedia Interface (HDMI), DisplayPort (DP) interface, embedded DisplayPort (eDP) interface, low-voltage differential signal-transmission (LVDS) interface, Universal Serial Bus (USB) interface, USB Type-C interface, etc., but the invention is not limited thereto. The display device 200 can be, for example, a liquid-crystal display panel, a light-emitting diode (LED) display panel, an organic light-emitting diode (OLED) display panel, etc., but the invention is not limited thereto.

The computer device 10 further includes one or more cameras 20 that are configured to capture a sequence off operation images of the keyboard 150. The cameras 20 may be implemented using a complementary metal oxide semiconductor (CMOS) sensor or a charge coupled device (CCD) sensor, but the invention is not limited thereto.

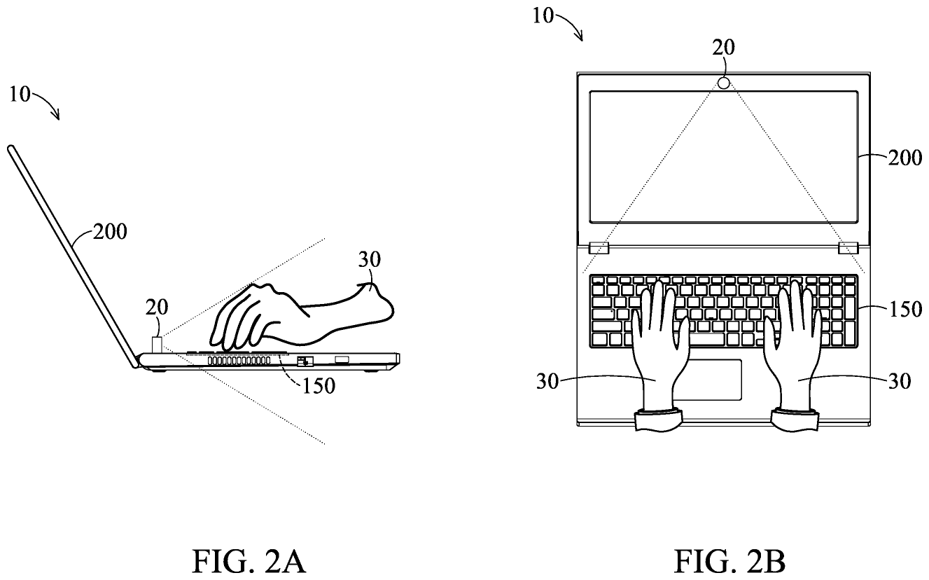

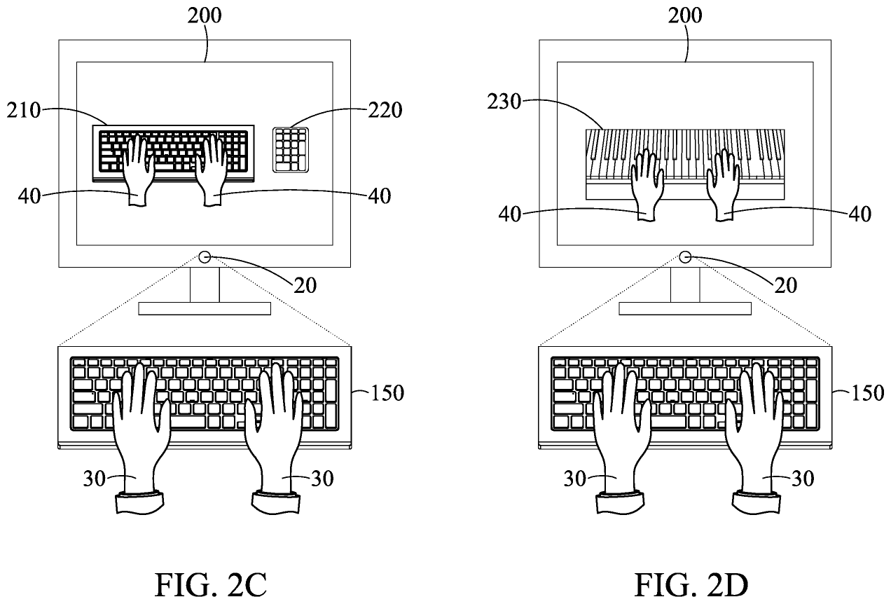

FIGS. 2A-2D are diagrams of usage scenarios of the computer device 10 in accordance with different embodiments of the invention. Please refer to FIG. 1 and FIGS. 2A-2D.

In an embodiment, if the computer device 10 is a laptop computer, the camera 20, for example, can be disposed above or below the display region of the display device 200 of the computer device 10 (as shown in FIG. 2B), or disposed in the front of the keyboard 150 which is close to the area of the display device 200 (as shown in FIG. 2A), and the field of view of the camera 20 can cover the entire keyboard 150.

In another embodiment, if the computer device 10 is a personal computer and the host 100 and the display device 200 are disposed separately, the camera 20 can be disposed above or below the display region of the display device 200, and the field of view of the camera 20 can cover the entire keyboard 150, as shown in FIG. 2C. In the embodiment 200, the display device 200 may transmit the operation image captured by the camera 20 to the host 100 through a USB protocol (e.g., through a USB connection). In yet another embodiment, the camera 20 may be a standalone camera (e.g., a web camera), and is electrically connected to the host 100 (e.g., via a USB connection), and the field of view of the camera 20 can also cover the entire keyboard 150.

Specifically, no matter which configuration of the camera 20 is used, the camera can capture the entire region of the keyboard 150, for example, including an operation image of the user using the keyboard 150 to type. The AR keyboard program 132 may include, for example, a trained artificial-intelligence (AI) model for image recognition, so as to instantly determine whether there are one or more specific objects (e.g., user's hand, keyboard keys, key texts, or other objects) in the operation image. When the AR keyboard program 132 determines that one or more specific objects exits in the current operation image, the AR keyboard program 132 assigns appropriate boundaries to each specific object.

Please refer to FIG. 2C. For example, the AR keyboard program 132 may receive the device information reported by the keyboard 150 to obtain the corresponding product model, size, number of keys, and key arrangement of the keyboard 150, and may detect the language and type of the input method currently used by the operating system 131, such as English, Chinese/Zhuyin, Chinese/Cangjie, etc., but the invention is not limited thereto. The AR keyboard program 132 may display the virtual keyboard 210 and text or symbol on each key of the virtual keyboard, which correspond to the language and type of the input method, on the display device 200 according to the arrangement of keys on the keyboard 150. That is, the virtual text on each key of the virtual keyboard 210 corresponds to the language and type of the input method.

In addition, the user may also simultaneously enable the function of the on-screen keyboard of the currently used input method, and adjust the display position of the on-screen keyboard 220 on the display device 200. The user can also set the display position of the virtual keyboard 210. For example, the display position of the virtual keyboard 210 can completely overlap with the on-screen keyboard 220, which means the virtual keyboard 210 is the main one. Alternatively, the display position of the virtual keyboard 210 can be adjusted so as not to overlap of the on-screen keyboard 220. For example, when the on-screen keyboard 220 is displayed at the lower right of the display device 200, the AR keyboard program 132 can display the virtual keyboard 210 at the lower middle or lower left of the display device 200, as shown in FIG. 2C.

In some embodiments, the user can also adjust the size of the virtual keyboard 210 displayed by the AR keyboard program 132. For example, the AR keyboard program 132 can adjust the size of the virtual keyboard 210 and the AR hand object 40 according to the resolution and actual size of the display device 200. When the resolution and actual size of the display device 200 are larger, the size of the virtual keyboard 210 and the AR hand object 40 displayed by the AR keyboard program 132 will be larger, and may be even be equal to the size of the keyboard 150, so the user can clearly see the typing operation of the AR hand object 40 above the virtual keyboard 210 on each virtual keyboard key on the display device 200. When the resolution and actual size of the display device 200 are smaller, the size of the virtual keyboard 210 and the AR hand object 40 displayed by the AR keyboard program 132 will be smaller.

When the AR keyboard program detects that there is a hand in the operation image captured by the camera 20, the AR keyboard program 132 can further detect the user's hand 30 and the position, size, and boundary of each keyboard key, and superimpose the AR hand object 40, which may be the user's hand object rendered by augmented reality, on the virtual keyboard 210 according to the detected boundaries. When the user's hand 30 is typing on the keyboard 150, the AR keyboard program 132 can also superimpose the AR hand object on the corresponding key positions of the virtual keyboard 210 during the typing operation. That is, the user can see the AR hand object 40 on the virtual keyboard 210 displayed on the display device 200 will also perform typing operations at the corresponding positions.

In some embodiments, the user can set the transparency of the AR hand object so that the user can clearly see the contact position of the AR hand object 40 on the virtual keyboard 210 from the display device 200, that is, the position of the user's hand 30 on the keyboard 150 can be known at the same time. Accordingly, the user can directly view the virtual keyboard 210 displayed on the display device 200 to know the position of the user's hand 30 on the keyboard 150 (i.e., the keyboard keys that are touched), thus reducing the number of input errors during blind typing, thereby increasing the user's typing efficiency and improving the user experience.

Please refer to FIG. 2D. In another embodiment, the user can set the current usage scenario of the AR keyboard program 132. The AR keyboard program 132 can, for example, change the virtual keyboard 210 in FIG. 2C into virtual piano keys 230 according to the current usage scenario (e.g., the piano-playing mode), and the user can use the keyboard 150 as the physical piano keys to play. The AR keyboard program 132 can also detect the playing action of the user's hand 30 from the operation image capture by the camera 20, and superimpose the corresponding AR hand object 40 on the virtual piano keys 230. Accordingly, the user can see his or her own playing action on the virtual piano keys 230 on the display device 200, thereby enhancing the user experience. In other words, the processor 110 can change the virtual keyboard 210 to a virtual object (e.g., virtual piano keys 230) corresponding to the current usage scenario set by the AR keyboard program 132, but the invention is not limited thereto.

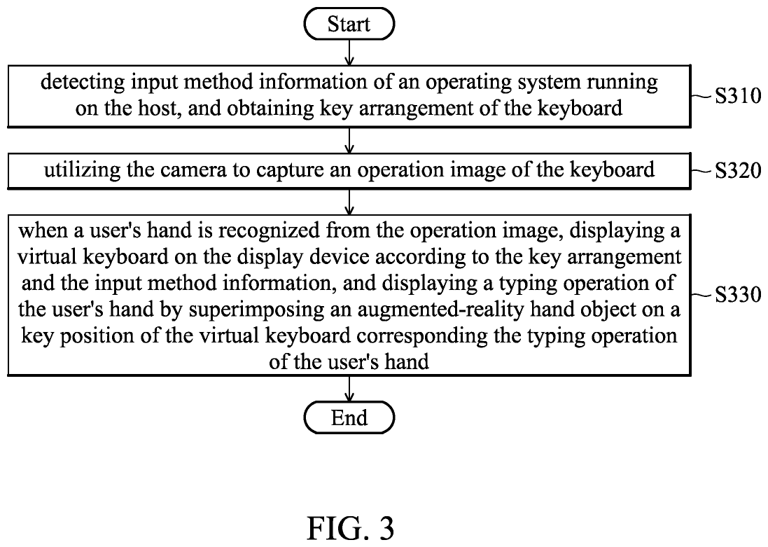

FIG. 3 is a flow chart of a method for display an augmented-reality virtual keyboard in accordance with an embodiment of the invention. Please refer to FIG. 1 and FIG. 3.

Step S310: detecting input method information of the operating system running on the host 100, and obtaining the key arrangement of the keyboard 150. For example, the AR keyboard program 132 may receive the device information reported by the keyboard 150 to obtain the corresponding product model, size, number of keys, and the key arrangement of the keyboard 150, and may detect the language and type of the input method currently used by the operating system 131, such as English, Chinese/Zhuyin, Chinese/Cangjie, etc., but the invention is not limited thereto.

Step S320: utilizing the camera 20 to capture an operation image of the keyboard 150. For example, the camera 20 may be arrange in different regions depending on the type of the computer device 10. If the computer device 10 is a laptop computer, the camera 20, for example, can be disposed above or below the display region of the display device 200 of the computer device 10 (as shown in FIG. 2B), or disposed in the front of the keyboard 150 which is close to the area of the display device 200 (as shown in FIG. 2A), and the field of view of the camera 20 can cover the entire keyboard 150. If the computer device 10 is a personal computer and the host 100 and the display device 200 are disposed separately, the camera 20 can be disposed above or below the display region of the display device 200, and the field of view of the camera 20 can cover the entire keyboard 150, as shown in FIG. 2C. In addition, the camera 20 may be a standalone camera (e.g., a web camera), and is electrically connected to the host 100 (e.g., via a USB connection), and the field of view of the camera 20 can also cover the entire keyboard 150.

Step S330: when the user's hand 30 is recognized in the operation image, displaying a virtual keyboard 210 on the display device 200 according to the key arrangement and the input method information, and displaying the typing operation by superimposing an AR hand object 40 on the key position of the virtual keyboard 210 corresponding the typing operation of the user's hand 30.

In view of the above, a computer device and a method for displaying an augmented-reality virtual keyboard are provided, which are capable of utilizing the camera to capture the operation image of the user's hand on the keyboard of the computer device, and displaying a virtual keyboard corresponding to the key arrangement of the keyboard on the display device. In addition, the augmented-reality keyboard program 132 executed by the computer device can recognize the typing operation of the user's hand in the operation image, and superimpose the augmented-reality hand object on the virtual keyboard so that the user can clearly see the keyboard keys currently touched by his or her typing operation from the display device. This can reduce input errors during blind typing, thereby increasing the user's typing efficiency and improving the user experience.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

1. A computer device, comprising:
a display device; and
a host, comprising:
a keyboard;
a camera;
a storage device, configured to store an augmented-reality keyboard program; and
a processor, configured to execute the augmented-reality keyboard program to perform the following steps:
detecting input method information of an operating system running on the host, and obtaining key arrangement of the keyboard;
utilizing the camera to capture an operation image of the keyboard; and
when a user's hand is recognized in the operation image, displaying a virtual keyboard on the display device according to the key arrangement and the input method information, and displaying a typing operation of the user's hand by superimposing an augmented-reality hand object on a key position of the virtual keyboard corresponding the typing operation of the user's hand;
wherein the processor adjusts sizes of the virtual keyboard and the augmented-reality hand object according to a resolution and actual size of the display device.

2. The computer device as claimed in claim 1, wherein the input method information comprises a language and a type of an input method currently being used by the operating system, and the processor obtains a product model, size, number of keys, and the key arrangement corresponding to the keyboard from device information reported by the keyboard,
wherein a virtual text on each virtual keyboard key of the virtual keyboard corresponds to the language and the type of the input method.

3. (canceled)

4. The computer device as claimed in claim 1, wherein the augmented-reality keyboard program comprises an image-recognition artificial-intelligence model to recognize the user's hand in the operation image, and to assign a boundary to the recognized user's hand, and to superimpose the augmented-reality hand object on the virtual keyboard according to the boundary.

5. The computer device as claimed in claim 2, wherein the processor further changes the virtual keyboard to a virtual object corresponding to a current usage scenario set by the augmented-reality keyboard program.

6. A method for displaying an augmented-reality keyboard, for use in a computer device, wherein the computer device comprises a camera, a keyboard, and a display device, the method comprising:
detecting input method information of an operating system running on the host, and obtaining key arrangement of the keyboard;
utilizing the camera to capture an operation image of the keyboard; and
when a user's hand is recognized in the operation image, displaying a virtual keyboard on the display device according to the key arrangement and the input method information, and displaying a typing operation of the user's hand by superimposing an augmented-reality hand object on a key position of the virtual keyboard corresponding the typing operation of the user's hand;
adjusting sizes of the virtual keyboard and the augmented-reality hand object according to a resolution and actual size of the display device.

7. The method as claimed in claim 6, wherein the input method information comprises a language and a type of an input method currently being used by the operating system, and the method further comprises: obtaining a product model, size, a number of keys, and the key arrangement corresponding to the keyboard from device information reported by the keyboard,
wherein a virtual text on each virtual keyboard key of the virtual keyboard corresponds to the language and the type of the input method.

8. (canceled)

9. The method as claimed in claim 6, further comprising:
utilizing an image-recognition artificial-intelligence model to recognize the user's hand in the operation image, and to assign a boundary to the recognized user's hand, and to superimpose the augmented-reality hand object on the virtual keyboard according to the boundary.

10. The method as claimed in claim 7, further comprising:
changing the virtual keyboard to a virtual object corresponding to a current usage scenario set by an augmented-reality keyboard program running on the computer device.
